(19) United States
(12) Patent Application Publication
(10) Pub. No.: US 2013/0200791 A1
(43) Pub. Date: Aug. 8, 2013

(54) WIRELESS ELECTRICAL POWER SUPPLY UNIT AND ARRANGEMENT COMPRISING A LIGHT TRANSMISSIVE COVER AND LIGHTING SYSTEM

(71) Applicants: Maarten Marinus Johannes Wilhelmu Van Herpen, Eindhoven (NL); Oscar Hendrikus Willemsen, Eindhoven (NL)

(72) Inventors: Maarten Marinus Johannes Wilhelmu Van Herpen, Eindhoven (NL); Oscar Hendrikus Willemsen, Eindhoven (NL)

(73) Assignee: KONINKLIJKE PHILIPS ELECTRONICS N.V., EINDHOVEN (NL)

(21) Appl. No.: 13/880,093

(22) PCT Filed: Oct. 17, 2011
(86) PCT No.: PCT/IB2011/054592

§ 371 Date: Apr. 18, 2013

(30) Foreign Application Priority Data
Oct. 28, 2010 (EP) 10189192.7

(51) Int. Cl. F21V 23/02

(52) U.S. Cl. CPC F21V 23/02
USPC 315/71

(57) ABSTRACT

The invention provides a wireless electrical power supply unit (100) comprising a sender connector (120) configured to transfer wireless electrical power by means of an AC signal to an external receiver connector (320). The invention further provides an arrangement (400), wherein such wireless electrical power supply (100) may be applied, comprising a light transmissive cover (410) and a lighting system (420) configured to provide lighting system light (421) through the light transmissive cover (410), wherein the lighting system (420) comprises the receiver connector (320) configured to receive wireless electrical power, by means of an AC signal (of the wireless electrical power supply unit (100)).

### FIELD OF THE INVENTION

The invention relates to a wireless electrical power supply unit and an arrangement comprising a light transmissive cover and lighting system.

### BACKGROUND OF THE INVENTION

Textiles with electronic components are known in the art. For instance, WO2009066226 describes a carpet comprising a primary backing layer provided with yarns forming tufts, a second backing layer, an adhesive layer provided between the primary backing layer and the second backing layer, LEDs and a conductor arrangement for the LEDs, wherein the primary layer, the adhesive layer and the second layer have substantially the same surface area, the adhesive layer and the primary backing layer are substantially permeable to light and the LEDs, the conductor arrangement and the second backing layer are arranged so as to allow the light from the LEDs to reach the adhesive layer.

### SUMMARY OF THE INVENTION

A problem with light emitting carpets and light emitting (coated) textiles, but also in other applications such as wall coverings, is how to provide the light sources, such as LEDs, with power in a way that is easy to install and robust.

In addition, the challenge is to find a connector that is thin enough, for example to fit below a carpet or carpet tile, or wallpaper covering, and is still robust. In the case of coated textiles, the problem may be that the LEDs are embedded within the textile. It is often not allowed or not desired to make a hole in the textile to make an electrical connection with the LEDs, because the coated textile would then lose its protective properties.

The reason why electric connectors are normally not thin enough is because a certain amount of thickness is required to make a robust connection between the electronic parts that have to be connected electronically.

It is a challenge to provide a power supply unit which may easily arranged at the desired place, especially without the need of making (difficult) connections, for instance by way of soldering a connection. It is a desire to provide a power supply unit that may be arranged in such a way, that together with the electronic device it powers, a (male-female) combination can be formed that may minimize stress on the unit, device and combination.

Hence, it is an aspect of the invention to provide an alternative power supply unit as well as an alternative arrangement of cover layer, lighting system and power source, which preferably further at least partly obviate one or more of above-described drawbacks.

The solution proposed here is to use wireless power to transfer power to the electronic device, such as a lighting system, like a lighting system comprising LEDs, behind a cover layer, such as in a light emitting carpet, light emitting coated textile structure, or other arrangement wherein a lighting unit is covered by a light transmissive cover.

In a first aspect, the invention provides a wireless electrical power supply unit comprising:
a housing comprising an AC signal generating unit;
a external electrical power supply connector, in electrical connection with the AC signal generating unit, for connecting the wireless electrical power supply unit to an electrical power supply;
a sender connector in electrical connection with the AC signal generating unit, and configured to transfer wireless electrical power by means of an AC signal to an external receiver connector, wherein the wireless electrical power supply unit has a height smaller than 5 mm.

In this way, the invention provides an electrical power source that may be easily arranged behind a transmissive cover (herein also indicated as “cover”), such as wall paper or carpet, and may also be robust. The power may be provided at the desired location.

Further, there may be no need for harming the integrity of the cover layer by penetration of wires or electrodes, etc.

Further, this solution may have an installation advantage because this may facilitate cut-to-measure solutions and may avoid the necessity to make physical connections (for instance by soldering), for instance while applying plaster or wallpaper or arranging a carpet or carpet tiles.

In addition, the wireless electrical power supply unit may be to such an extent thin, that the presence of the wireless electrical power supply unit may substantially be unnoticed by an observer (downstream of the transmissive cover). Especially, the wireless electrical power supply unit, such as the housing, has a height smaller than 5 mm, such as smaller than 2 mm, like smaller than 1 mm, which may depend on the cover layer it is intended to be used with. For instance, in the case of for example an intended carpet as cover layer, the maximum height of the wireless electrical power supply unit (i.e. of amongst others the housing) may for instance be in the range of 0.1-1 mm, such as about 0.5 mm. But also in other embodiments this may be beneficial. Would the wireless electrical power supply have a larger height, especially larger than 5 nm, the presence thereof might be detected by observers, which might not be desired. Further, height differences may be detrimental to the wireless electrical power supply, the lighting system or the cover layer, especially under pressure on the cover layer (for instance when arranged under a carpet (tile)). Hence, the height is especially smaller than 5 nm, even more especially smaller than 1 mm.

Hence, the housing is preferably small, flat, and thin. The term “flat” herein refers to an object having a (mean) height which is smaller than the length and the width. Hence, not only the housing is subject to the herein indicated height restriction, but also other parts, such as an optional (flexible) branch unit including the sender connector, see also below.

Herein, the term “wireless” thus refers to the transfer of energy from the wireless electrical power supply unit to a device comprising the receiver connector. The wireless electrical power supply unit itself may be connected to the external electrical power supply via a wire (see also below) in order to receive electrical power from the external electrical power supply. The wireless aspect thus refers to a transfer of electrical energy from the wireless electrical power supply unit to another device, without conductive electrical contact between the devices. A physical contact between the power supply unit and the other device, hence, is especially separated by an electric isolating layer. This can be part of the power supply unit, or of the other device, it may be an external isolator, including an air gap, etc. Such wireless electrical energy transfer can be provided via different principles, all based on AC signals.

To this end, the wireless electrical power supply unit comprises an AC signal generation unit which is configured to convert the electrical power received via the external electrical power supply connector from an external electrical power source to a suitable AC signal. In general, such AC signal may have a frequency in the range of about 1 kHz-1 MHz. The AC signal is also induced in the receiver connector of the other device. The receiver connector is configured to receive wireless electrical power by means of said AC signal from the sender connector. In an embodiment, the sender connector is configured to transfer the AC signal via inductive power transfer or via resonant inductive power transfer, especially resonant inductive power transfer. In yet another embodiment, the sender connector is configured to transfer the AC signal via capacitive power transfer or via resonant capacitive power transfer, especially resonant capacitive power transfer. The inductive or capacitive coupling is done in a way that is easily recognized by a person skilled in the art. For instance an inductive power transfer system may include a soft magnetic material to guide the flux with the aim to increase the efficiency of the power transfer and/or for better shielding of the magnetic fields. Especially preferred is resonant inductive power transfer.

The external electrical power supply connector may be an electric wire or may be a plug or socket. Via the external electrical power supply connector, the wireless electrical power supply unit can be connected to an (external) electrical power supply (such as the mains, or electronics comprising a transformer/adapter, connected to the mains). The external electrical power supply connector is part of the wireless electrical power supply unit, but the external electrical power supply is not. Hence, in an embodiment, the electrical power supply or source is remote, for instance at least 1 m from the wireless electrical power supply unit.

The sender connector is in electrical connection with the AC signal generating unit. Hence, it receives power from the AC signal generating unit (which on its turn receives electrical power from the (external) electrical power supply). The AC signal generating unit is configured to transfer wireless electrical power by means of an AC signal (received from the AC signal generating unit) to an external receiver connector. Again, the external receiver connector is not part of the wireless electrical power supply unit (but is part of an external device, such as a lighting system (see also below). The sender connector may in an embodiment comprise a coil but may in another embodiment comprise plates for capacitive transfer of the AC signal to the receiver connector.

The term “sender connector” is applied to indicate that this connector provides electrical energy (“source” or “socket” or “sender”), whereas the connector comprised by the receiving electric device, such as a lighting system only receives electrical energy, and can be considered a “receiver” (or “plug”). Even without physical contact between the receiver connector and the sender connector, the lighting system, or other electronic device, may be powered.

As will be clear to a person skilled in the art, the receiver connector (not part of the wireless electrical power supply unit) may comprise a coil or plates, respectively, dependent upon the type of sender connector is applied.

The sender connector may be integrated in the housing, for instance on, in or within the housing. However, the sender connector may also be remote from housing, for instance by using a connecting arm or wire or flap. As indicated above, such remote arrangement of the sender connector is also subject to the height requirement as indicated above.

Hence, in an embodiment, the wireless electrical power supply unit may further comprise a branch unit, wherein the branch unit comprises the sender connector. For instance via electrical wires within the branch unit, the sender connector stays in electrical connection with the AC signal generation unit. In a specific embodiment, the branch unit comprises an adhesive layer. For instance, the branch unit may comprise a sticker. In an embodiment, the sender connected is integrated in a sticker. This may facilitate the connection between the receiver connector and sender connector, for instance because the sticker can be adhered to the device comprising the receiver connector, especially close to or even attached to the receiver connector.

As will be clear to a person skilled in the art, the sender connector and/or receiver connector, preferably both are configured to be electrically insulated from each other. Hence, especially the sender connector is in electrical contact with the AC signal generating unit, but is further guarded from the exterior, for instance by a plastic coating (or by the housing, dependent upon where the sender connector is arranged). Likewise, the receiver connector will be in electrical contact with one or more electrics, but is preferably further guarded from the exterior, for instance by a plastic coating (or by a housing of such device, dependent upon where the sender connector is arranged).

Especially a flexible connection between the sender connector and AC signal generation unit may be of use. This may further add to the degree of freedom of arranging the cover and/or the wireless electrical power supply unit. Hence, in an embodiment, the sender connector is in flexible connection with the AC signal generating unit. For instance, a flexible branch unit may be applied. Such branch unit may in essence be an electrical wire electrically connected to the sender connector (and of course the AC signal generation unit). The branch unit preferably has a height smaller than 1 mm, such as smaller than 0.5 mm, especially smaller than 0.25 mm, such as in the range of 0.05 mm-1 mm, like 0.05-0.2 mm.

The wireless electrical power supply unit may further comprise a control unit for controlling a lighting system, or another electronic device, that is configured to receive electrical power via the sender connector and wherein the control unit is further configured to receive a control signal from an external controller (like a wireless remote control). As indicated above, the electronic device, such as the lighting system (comprising the receiver connector), is not part of the wireless electrical power supply unit. Assuming a lighting unit to be controlled, the control unit may for instance be configured to control one or more features selected of the group consisting of color, color temperature, intensity, number of lighting units switched on or off, etc.

As indicated above, in an embodiment, the wireless electrical power supply unit can be used to provide electrical energy to a device below a transmissive cover. Especially, such device comprising a receiver connector might be a lighting system. The receiver connector may optionally be remote from the lighting system, such as comprised by a (flexible) branch of such device.

Hence, in a further aspect, the invention provides an arrangement comprising a light transmissive cover and a lighting system configured to provide lighting system light through the light transmissive cover, wherein the lighting system comprises a receiver connector configured to receive wireless electrical power by means of an AC signal. In a specific, the arrangement may comprise a light transmissive cover and a plurality of lighting systems. The lighting system comprising the receiver connector, can be seen as a “plug” related to the herein described wireless electrical power supply, with sender connector, which can be seen as “socket”.

The cover can be part of a larger structure, such as a textile layer of a textile or a carpet layer of a carpet, but may also be the textile or carpet itself. Hence, in an embodiment, the cover comprises a textile layer. In another embodiment, the arrangement comprises a textile product, and wherein the lighting system is embedded in the textile product. In yet another embodiment, the cover comprises a carpet layer. In yet a further embodiment, the arrangement comprises a carpet product, and wherein the lighting system is embedded in the carpet product.

The term “carpet product” herein refers in an embodiment to (tufted) carpets, but may in an embodiment also refer to (tufted) rugs and in another embodiment also to (tufted) goblins. The term “carpet product” may also include (tufted) carpet tiles, such as a carpeted area substantially consisting of an arrangement of (adjacent) (tufted) carpet tiles.

In an embodiment, the lighting system is embedded within the carpet (tile) or coated textile and the lighting system comprises a receiver connector for wireless power. Especially in such embodiment, wireless power transfer may be desired because this may allow maintaining the integrity of the carpet (tile) or coated textile.

In yet a further embodiment, the light transmissive cover comprises a material selected from the group consisting of wallpaper, especially one or more of vinyl wall paper and glass fiber wall paper. In again another embodiment, the light transmissive cover comprises a material selected from the group consisting of plaster, especially one or more of stone plaster, stucco plaster, synthetic resin plaster, rustic plaster, limestone plaster, and venetian plaster. In an embodiment, the lighting system may be embedded in such material (with the cover on top of the lighting system). In again another embodiment, the light transmissive cover comprises a material selected from the group consisting PVC flooring, paint, and laminate flooring.

Especially, the light transmissive cover has a light transmission for light generated by the lighting system in the range of 0.5-30%, especially in the range of 1-20%. Such cover may hide the lighting system for a viewer, but allow the lighting system light penetrate through the covering material (see also below). The lighting system may comprise one or more lighting units, and for instance also electrically connecting cables, etc. The lighting unit in general comprises a plurality of light sources, especially LEDs.

The indicated transmission range may on the one hand provide enough transmission through the cover, for instance to make the light effect even visible under typical office lighting conditions, especially assuming state of the art LEDs, preferably solid state LEDs, but on the other hand, may substantially prevent visibility of elements (such as for example the light source) under the (floor, wall, ceiling, textile) cover (or other elements behind the cover). Visibility of for instance the wall, floor or ceiling, or other elements behind the cover may especially not be desired, because the light source (or other elements, like electric wires, reflective foil, a padding) may no longer be hidden. The principle presented here may also be indicated as “hide light”: the light sources may be hidden and not visible to a user of the cover, while the light generated thereby is visible to the user.

An additional advantage of the current invention may be that the cover may protect the lighting system and/or wireless electrical power supply unit that is underneath.

The transmission or light permeability can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

The arrangement indicated above may especially comprise the wireless electrical power supply unit as indicated above. The sender connector of the wireless electrical power supply transfers (during use) electrical energy to the receiver connector of the (lighting system (or other electronic device)) of the arrangement. In this way, the lighting system, especially its receiver connector, and the wireless electrical power supply, especially its sender connector, are arranged as “plug-socket”.

In a specific embodiment, the arrangement comprises a plurality of wireless electrical power supply units. In yet a further specific embodiment, the arrangement comprises a light transmissive cover and a plurality of lighting systems and a plurality of wireless electrical power supply units, respectively, wherein the latter are configured to wireless power the former.

In a specific embodiment, the height of lighting system and wireless electrical power supply unit, when arranged to allow wireless electrical power transfer from the electrical power supply unit to the lighting system during use of the lighting system and electrical power supply unit, is smaller than 5 mm, such as smaller than 1 mm. This implies that when the lighting system and wireless electrical power supply unit are arranged to be used, i.e. the during use of the lighting unit the lighting unit is electrically powered wireless by the wireless electrical power supply, the height of the lighting system and power supply unit, whatever arrangement is chosen (next to each other, on top of each other, partly on top of each other, partly integrated, etc.), is smaller than 5 mm, such as smaller than 1 mm. This may facilitate invisibility of the presence of the lighting system and wireless electrical power supply unit, especially when having a height smaller than 1 mm.

In a specific embodiment, the lighting system (or other electronic device wireless powered by the wireless electrical power unit) has a recess for hosting at least part of the wireless electrical power supply unit. For instance, the lighting system may have a cavity, wherein the wireless electrical power unit may be (partially) arranged. Such embodiment especially allows the lighting unit and the wireless electrical power unit to have the same height. This may add to invisibility, robustness and compactness. For instance, an adjacent arrangement embodiment of wireless electrical power supply unit and electronic device (such as the lighting system), having equal heights may be robust and beneficial for esthetical reasons.

The lighting system, or other electronic device, may additionally or alternatively have second recess, configured to host at least part of the branch unit (if using a wireless electrical power unit with such branch unit). Again, this may facility to robustness and compactness. Both recesses may be used to keep the height of the combination of lighting system (or other electronic device) and wireless electrical power unit at the defined height.

Hence, in a specific embodiment, the electronic device, especially the lighting system, has a height smaller than 5 mm, especially smaller than 2 mm, like smaller than 1 mm. For instance, the maximum height of the lighting unit may for instance be in the range of 0.1-1 mm, such as about 0.5 mm.

The arrangement may be a textile (such as clothes), but may also include a floor, wall or ceiling cover. Hence, in an embodiment the arrangement comprises a stack, wherein the stack comprises a support selected from the group consisting of a floor, a wall and a ceiling, the wireless electrical power supply unit as defined here, and the light transmissive cover.

The arrangement may in an embodiment comprise a plurality of lighting systems. In a further embodiment, the arrangement comprises a plurality of wireless electrical power supply units.

The wireless electrical power supply unit may in an embodiment comprise a plurality of sender connectors, each in electrical contact with the AC signal generating unit. Likewise, the wireless electrical power supply unit may comprise a plurality of branch units, each branch unit comprising at least one sender connector.

The principle of the invention may also be extended to other components. For instance, other types of electronics may be embedded in (coated) textiles or carpets or other covers. For example, sensors may be embedded into the covers, such as for example a light sensor, or a smoke detector. Another example of other electronics are communication systems, such as an RFID detector.

The lighting system is preferably an LED-based lighting system, and thus the light source(s) is (are) preferably (a) LEDs.

The term “substantially” herein will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1d schematically depict some possible embodiments of the wireless electrical power supply unit;

FIGS. 2a-2b schematically depict some possible embodiments of the sender connector and receiver connector;

FIGS. 3a-3g schematically depict some embodiments of the arrangement of transmissive cover, lighting unit and wireless electrical power supply unit; and

FIGS. 4a-4e some further aspects of combinations of wireless electrical power unit and electronic device, such as lighting system.

The figures are not necessarily on scale.

### DETAILED DESCRIPTION OF THE EMBODIMENTS

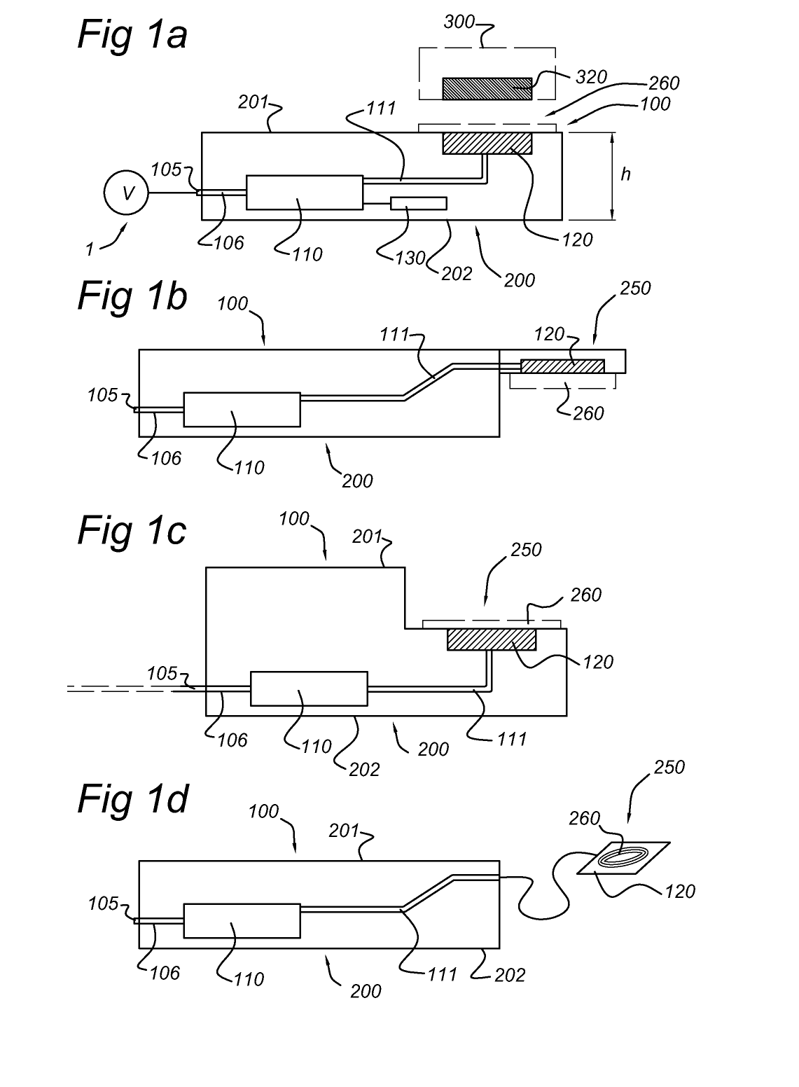

FIG. 1a schematically depicts a wireless electrical power supply unit 100, in combination with an electrical power supply 1 (external) and an electronic device 300, comprising a receiver connector 320, to which the wireless electrical power supply unit 100 may provide wireless electric power.

The wireless electrical power supply unit 100 comprises a housing 200 comprising an AC signal generating unit 110. The housing may for instance be a hard plastic material. Preferably, the housing 200 has a height h smaller than 5 mm, such as 0.5 mm or smaller. Here, the height is between the top face 201 of the housing 200 and the bottom face 202 of the housing 200.

The wireless electrical power supply unit 100 further comprises a external electrical power supply connector 105, such as a socket (or plug), or electric wire (with plug). The external electrical power supply connector 105 is in electrical connection with the AC signal generating unit 110. In this way, the wireless electrical power supply unit 100 may be connected to the electrical power supply 1, for example through an adapter that generates a low voltage power supply. The electrical power supply 1 is not part of the wireless electrical power supply unit 100, and is only depicted for the sake of understanding.

Further, the wireless electrical power supply unit 100 comprises a sender connector 120 in electrical connection with the AC signal generating unit 110. The sender connector 120 is configured to transfer wireless electrical power by means of an AC signal to the external receiver connector 320 of device 300. Electrical connections between the items are indicated with wires 106, connecting the external electrical power supply connector 105 with the AC signal generating unit 110 and 111, connecting the AC signal generation unit 110 to the sender connector 120.

By way of example, the wireless electrical power supply unit 100 further comprises a control unit 130, which may be used to control an external device, such as device 300 (such as a lighting system). The control unit 130 may also be present in embodiments described below, but are not always depicted in the accompanying drawings.

Especially, there is insulating material between the sender connector 120 and the receiver connector 320. For instance, a plastic coating may be arranged over the sender connector 120. By way of example, such optional coating is depicted with reference 260 (dotted structure on top face 201). Note that also an adhesive coating might be applied. Reference 260 also includes the option of a sticker. If present, additional layers (such as the optional coating 260) or other attributes part of the wireless electrical power supply unit 100 is included in the height requirement

The electrical connection 111, connecting the AC signal generating unit 110 and the sender connector 120 is especially not longer than 50 cm, such as not longer than 20 cm, especially not longer than about 10 cm.

FIG. 1b schematically depicts an embodiment, wherein the wireless electrical power supply unit 100 further comprises a branch unit 250. The branch unit 250 comprises the sender connector 120. The branch unit 250 may for be used to arrange over at least part of the electric device, such as a lighting system (see also below), that has to be powered wireless. The advantage of this approach is that the total height of power supply and lighting system (see below) does not increase too much, as they are arranged next to each other, instead of on top of each other. This is because the base of the connector contains the electric components that may inherently be thick. By way of example, the external electrical power supply connection 105 is here only a socket (to plug an electric cable in). FIG. 1c schematically depicts the same embodiment as schematically depicted in FIG. 1b, but now with a lower branch unit 250. Here by way of example, the external electrical power supply connector 105 is a cable, for instance to plug into an external electrical power supply socket.

FIG. 1d schematically depicts an embodiment wherein the sender connector 120 is in flexible connection with the AC signal generating unit 110. The branch unit 250 may comprise an electric wire, in connection with the sender connector 120. In this way, remote from the housing 200, the sender connector 120 may be applied (to a receiver connector; not depicted). This enhances freedom of arrangement of items. Here, the sender connector 120 (for instance a coil) may be comprised in a sticker, as indicated here with reference 260. The length of the electrical connection (111) between the sender connector 120 and the housing 200, more especially the AC signal generating unit 110 is especially smaller than 50 cm, in general smaller than 10 cm.

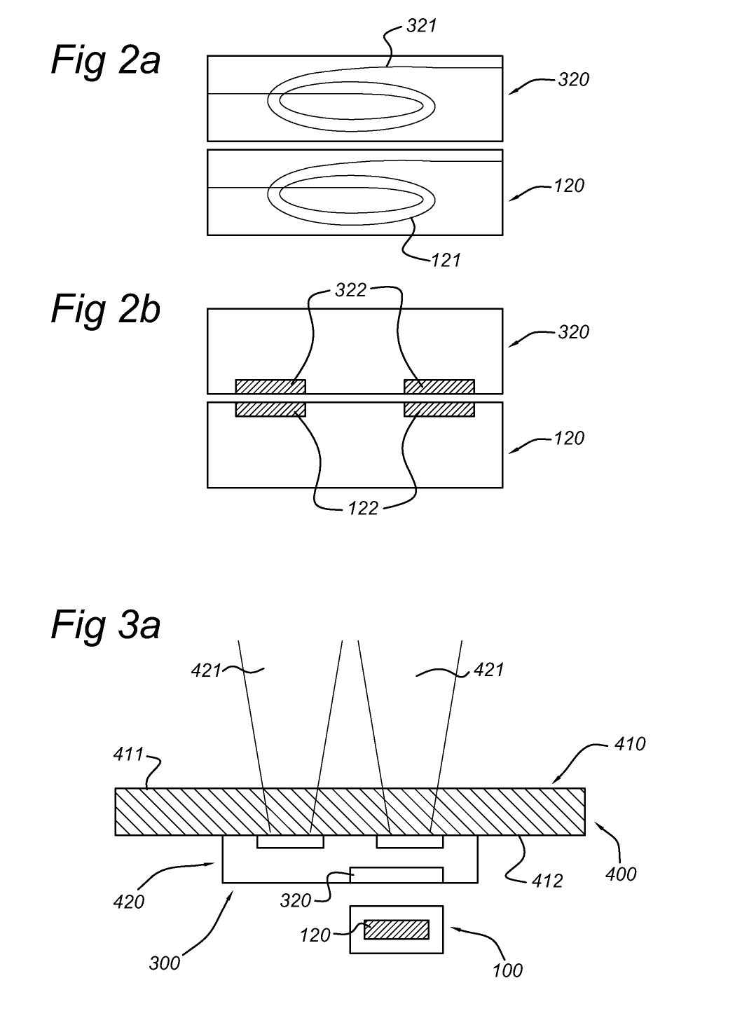

FIGS. 2a-2b schematically depict two embodiments, respectively, to transfer wireless electrical energy. In the former embodiment, both the sender connector 120 and the receiver connector 320 comprise coils 121, 321, respectively, for inductive power transfer. In the latter embodiment, capacitors are applied, indicated with reference 122,322, respectively, to transfer wireless electrical energy from the sender connector 120 to the receiver connector 320 via capacitive power transfer.

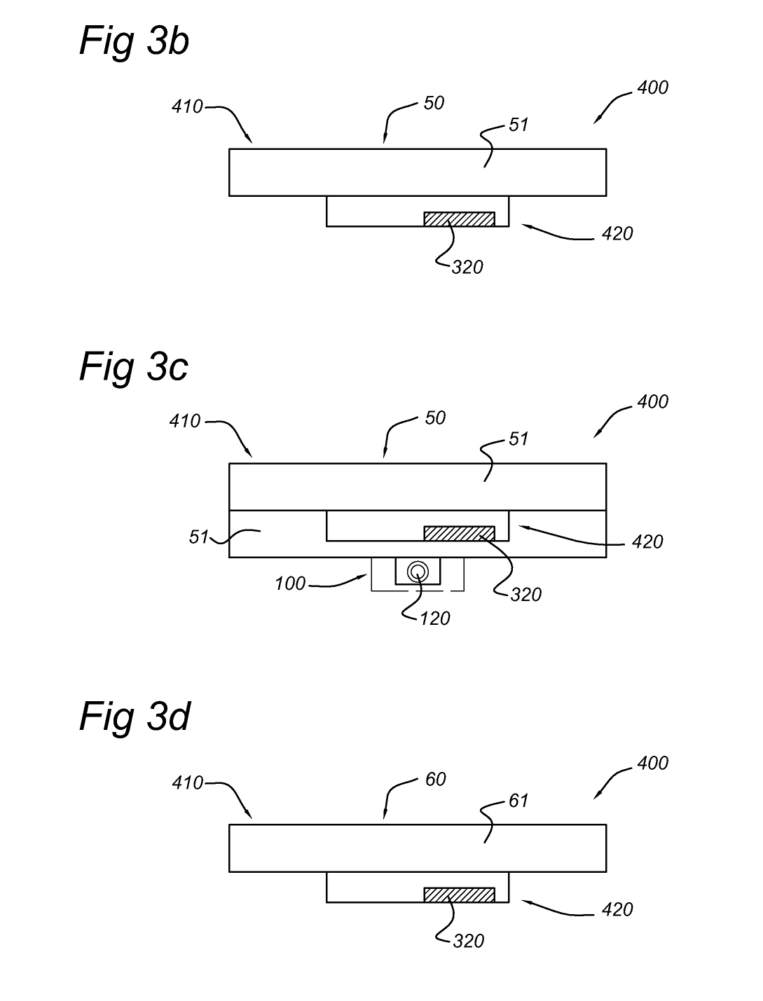

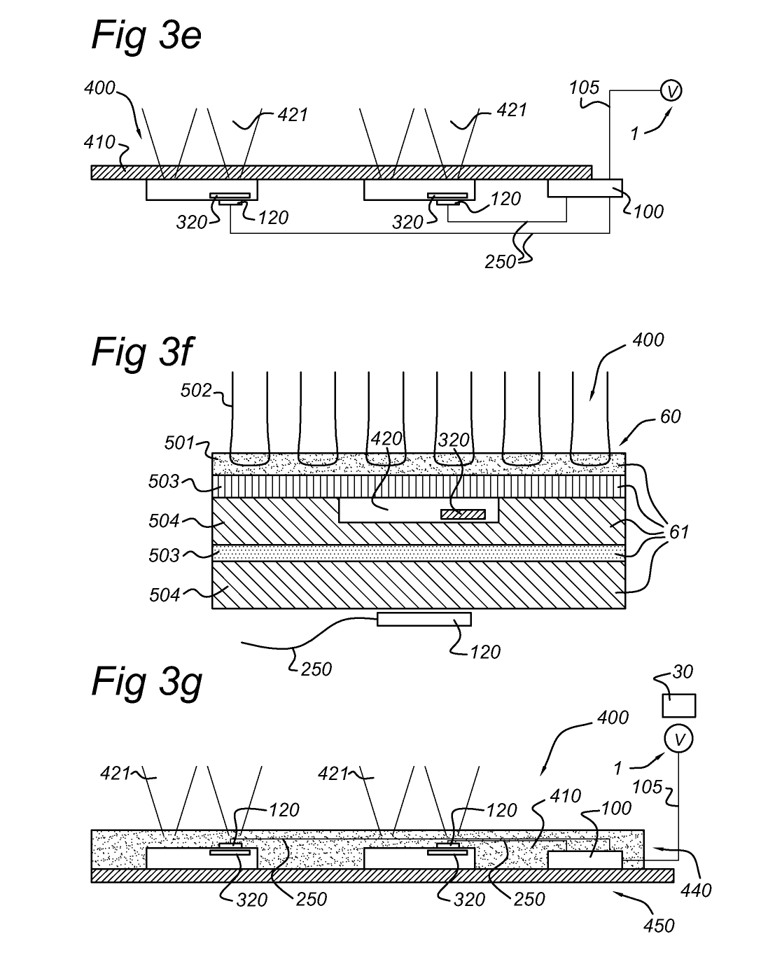

FIGS. 3a-3g schematically depict some possible embodiments of an arrangement 400, which comprises an electronic device 300. Here, the arrangement comprises light transmissive cover 410 and a lighting system 420 (as electronic device 300). The lighting system 420 is configured to provide lighting system light 421 through the light transmissive cover 410. Further, the lighting system 420 comprises a receiver connector 320 configured to receive wireless electrical power by means of an AC signal of the sender connector 120 of the wireless electrical power supply unit 100.

The light transmissive cover 410 (“cover”) ay be any material and may have any layer thickness, but material and layer thickness are chosen to have transmission for the lighting system light 421 of the lighting system 420. The cover 410 may be for instance be a carpet, or a carpet layer, a textile, or a textile layer, such as a coating on a textile, wall paper, plaster, etc. etc. The arrangement 400 may in an embodiment include the wireless electrical power supply unit 100, but the invention is also directed to an arrangement 400 without wireless electrical power supply unit 100. The cover has a front face 411, which is visible to a user or another observer when the arrangement is applied. Further, the cover has a back face 412, which is upstream of the front face 412.

The terms “upstream” and “downstream” relate to an arrangement of items or features relative to the propagation of the light from a light generating means (here the lighting system, especially the light source, such as the LED, which may be comprised by such lighting system), wherein relative to a first position within a beam of light from the light generating means, a second position in the beam of light closer to the light generating means is “upstream”, and a third position within the beam of light further away from the light generating means is “downstream”. The transparent cover 410 is thus downstream of the lighting system 420.

FIG. 3b schematically depicts an embodiment of the arrangement 400, wherein the cover 410 comprises a textile layer 51.

FIG. 3c schematically depicts an embodiment of the arrangement 400, wherein the arrangement 400 comprises a textile product 50, and wherein the lighting system 420 is embedded in the textile product 50. Here, by way of example the textile product 50 comprises two textile layers 51, between which the lighting system 420 is arranged. The cover layer 410/layer 51 may for instance be a PVC coating.

FIG. 3d schematically depicts an embodiment of the arrangement 400, wherein the cover 410 comprises a carpet layer 61.

FIG. 3e schematically depicts an embodiment, wherein the arrangement 400 comprises a carpet product 60, and wherein the lighting system 420 is embedded in the carpet product 60. FIG. 3e also depicts by way of example an embodiment of the arrangement comprising a plurality of lighting systems 420. As indicated above, the external electrical power supply 1 is not part of the wireless electrical power supply unit 100 or of the arrangement 400.

A specific example is shown in 3f. FIG. 3f schematically depicts an embodiment of the arrangement 400, wherein the arrangement 400 comprises a carpet or a carpet tile 60. Here, the lighting unit 420 is embedded in the carpet or carpet tile. The sender connector 120 is provided to send power to the receiver connector 320 of the lighting unit 420. The figure is also showing a light transmissive primary backing 501, fibers (or yarns) 502 that are tufted through the primary backing 501 to form a pile, a pre-coat adhesive coating 503 which secures the facing fibers to the primary backing 501, a reinforcing scrim 505 which may provide dimensional stability, a backing adhesive 504 which may secure the reinforcing scrim 505 to the primary backing 501.

FIG. 3g schematically depicts an embodiment of the arrangement 400 comprising a stack 440, wherein the stack 440 comprises (1) a support 450, such as selected from the group consisting of a floor, a wall and a ceiling, (2) the wireless electrical power supply unit 100, as described herein, and the light transmissive cover 410, such as wall paper, a carpet, etc. By way of example, an external controller 30 is depicted, for instance a remote control, to control the lighting system(s) 420, more precisely the lighting system light 421 generated thereby.

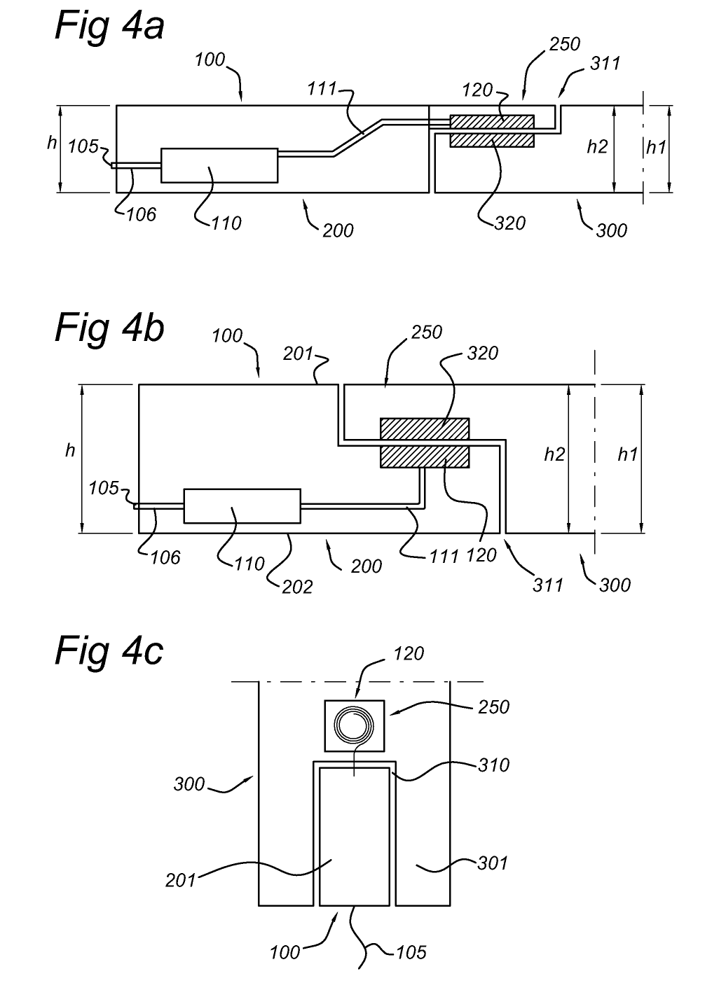

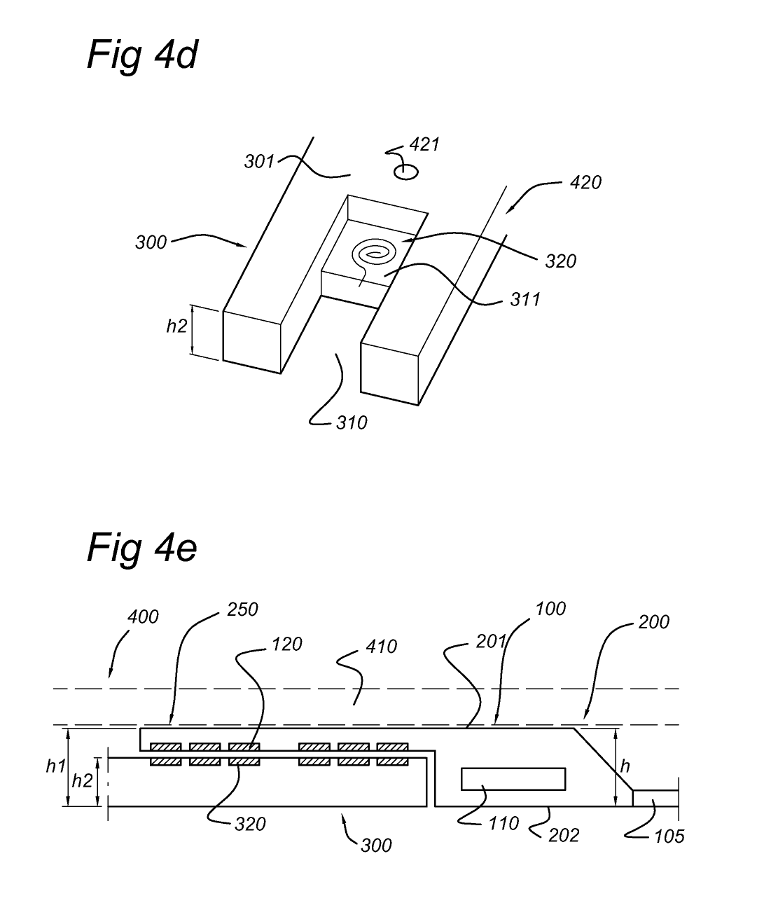

FIG. 4a schematically depicts a combination of an embodiment of the wireless electrical power supply unit 100 and electronic device 300, comprising receiver connector 320. The electrical power supply unit 100 and electronic device 300 are arranged to be used, i.e. electrical power supply can occur if desired. The electronic device may for instance be a lighting system (see also above). Here, the electronic device 300 comprises a recess 311, which may especially be configured to host at least part of the branch unit 250. In this way, the total height of the combination, indicated with reference h1, may (also) be smaller than 5 mm, such as smaller than 1 mm. FIG. 4b schematically depicts an alternative embodiment. In both embodiments, the recess is especially configured to host at least part of the branch unit 250, which may provide compactness and robustness of the combination, and may also be beneficial in view of the height of the combination. The height of the electrical power supply unit 100 is indicated with reference h, the height of the electronic device 300 is indicated with reference h2, and the height of the combination of electrical power supply unit 100 and electronic device 300 is indicated with h1. Configurations such as schematically depicted in FIGS. 4a and 4b preferably have a height of less than 5 mm, such as less than 1 mm.

FIG. 4c schematically depicts another type of recess, indicated with reference 310, which allows arrangement of at least part of the electrical power supply unit 100 into the recess 310 of the electronic device 300. Again, this may provide compactness and robustness of the combination, and may also be beneficial in view of the height of the combination. The recess 310 of the electronic device 300, especially configured for hosting at least part of the electrical power supply unit 100 is herein also indicated as first recess 310 and the recess 311, especially configured to host at least part of the branch unit 250 is herein also indicated as second recess 311.

FIG. 4d schematically depicts an embodiment wherein both the first recess 310 and the second recess 311 are comprised by the electronic device. The first recess 310 may be used to arrange at least part of the electrical power supply unit 100 in and the second recess 311 may be used to host at least part of the branch unit 250 (both not depicted for the sake of clarity). As will be clear to a person skilled in the art, the second recess 311 may comprise the receiver connector 320, as is by way of example schematically depicted in FIG. 4d. The embodiment as schematically depicted in FIG. 4d allows an adjacent arrangement embodiment of wireless electrical power supply unit 100 and electronic device 300 (such as the lighting system), having equal heights (h and h2, respectively; see also other figures), which may be robust and beneficial for esthetical reasons. In an alternative, the height of the electronic supply unit h is slightly smaller than the height h2 of the electronic device, in order to better protect the electronic supply unit against wear and tear. For example, when a combination with carpet is used, people will stand on top of the arrangement, and using a smaller height for the electronic supply unit will relieve some of the pressure on this unit.

FIG. 4e schematically depicts an embodiment wherein the branch unit 250 is at least partly arranged over the electronic device 300. In this way, electric energy transfer from the sender connector 120 to the receiver connector 320 may be facilitated.

The height of the branch unit 250 may be very small, for instance smaller than 1 mm, such as smaller than 0.5 mm, especially smaller than 0.25 mm, such as in the range of 0.05 mm-1 mm, like 0.05-0.2 mm, like 0.1 mm. This may for instance be the case when the branch unit 250 is a sticker comprising the sender coil 120. In this way, the height (h1) may be kept as low as possible. For robustness of the arrangement as well as for esthetical reasons, this may be beneficial.

Referring to FIG. 4e, this would imply that the difference between height h1 and height h2 would be about less than 0.5 mm, for instance 0.05-0.2 mm, like 0.1 mm.

Possible height differences of the electrical power supply unit 100, or between the housing 200 and the external electrical power supply connector 105, such as an electric wire, may especially be bridged by sloping faces.

Referring to FIG. 4e, the top surface 201 of housing 200 comprises a part that bridges height h of the housing and the height of the external electrical power supply connector 105. This may add to robustness of the electrical power supply unit 100. By way of example, schematically light transmissive cover 410 is depicted.

Referring to FIGS. 4a-4e, those embodiments are examples of embodiments that allow the height h1 of lighting system 420 and wireless electrical power supply unit 100, when arranged to allow wireless electrical power transfer from the electrical power supply unit 100 to the lighting system 420 during use of the lighting system 420 and electrical power supply unit 100, to be smaller than 5 mm, especially smaller than 1 mm.

Referring to FIGS. 1b-1d, 3a, 3e-3g and 4a-4e, the electrical power supply unit 100 as indicate above may further comprise control unit 130.

1.-7. (canceled)

8. An arrangement comprising:
a light transmissive cover,
a lighting system located behind the light transmissive cover and configured to provide lighting system light through the light transmissive cover, wherein the lighting system comprises a receiver connector configured to receive wireless electrical power, and
a wireless electrical power supply unit,
wherein the wireless electrical power supply unit comprises:
a housing comprising an AC signal generating unit,
an external electrical power supply connector, in electrical connection with the AC signal generating unit, for connecting the wireless electrical power supply unit (100) to an electrical power supply, and
a sender connector in electrical connection with the AC signal generating unit, and configured to transfer wireless electrical power by means of an AC signal to the external receiver connector of the lighting system,
wherein the wireless electrical power supply unit has a height smaller than 5 mm.

9. The arrangement according to claim 8, wherein the arrangement comprises a textile product, and wherein the lighting system is embedded in the textile product.

10. The arrangement according to 8, wherein the arrangement comprises a carpet product, and wherein the lighting system is embedded in the carpet product.

11. The arrangement according to claim 8, wherein the light transmissive cover comprises a material selected from the group consisting of wallpaper, especially one or more of vinyl wall paper and glass fiber wall paper, and of plaster, especially one or more of stone plaster, stucco plaster, synthetic resin plaster, rustic plaster, limestone plaster, and venetian plaster.

12. (canceled)

13. The arrangement according to claim 8, wherein the height of lighting system and wireless electrical power supply unit, when arranged to allow wireless electrical power transfer from the electrical power supply unit to the lighting system during use of the lighting system and electrical power supply unit, is smaller than 5 mm, especially smaller than 1 mm.

14. The arrangement according to claim 13, wherein the lighting system has a recess for hosting at least part of the wireless electrical power supply unit.

15. The arrangement according to claim 8, comprising a stack, wherein the stack comprises a support selected from the group consisting of a floor, a wall and a ceiling, (2) the wireless electrical power supply unit, and the light transmissive cover.

16. The arrangement according to claim 8, wherein the wireless electrical power supply unit further comprises a branch unit, and wherein the branch unit comprises the sender connector.

17. The arrangement according to claim 8, wherein the branch unit comprises an adhesive layer.

18. The arrangement according to claim 8, wherein the sender connector is in flexible connection with the AC signal generating unit.

19. The arrangement according to claim 8, wherein the wireless electrical power supply unit furthers comprises a control unit for controlling the lighting system and for receiving a control signal from an external controller.

20. The arrangement according to claim 8, wherein the sender connector is configured to transfer the AC signal via inductive power transfer, or via. resonant inductive power transfer, or via capacitive power transfer, or via resonant capacitive power transfer, especially via resonant inductive power transfer.

21. The arrangement according to claim 8, wherein the wireless electrical power supply unit has a height smaller than 1 mm.
